(19) United States
(12) Patent Application Publication
(10) Pub. No.: US 2008/0151423 A1
(43) Pub. Date: Jun. 26, 2008

(54) Spacer, manufacturing method of the spacer, disc drive having the storage

(75) Inventor: Masanori Ueda, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/902,123

(22) Filed: Sep. 19, 2007

(30) Foreign Application Priority Data
Dec. 26, 2006 (JP) 2006-349027

(51) Int. Cl. G11B 5/23

(52) U.S. Cl. 360/119.01

(57) ABSTRACT

A spacer is to be attached to a hub that rotates plural disc in a disc drive, configured to space two adjacent discs, and has an annular shape and an internal surface that opposes to the hub. The spacer includes three projections on the internal surface.

This application claims the right of a foreign priority based on Japanese Patent Application No. 2006-349027, filed on Dec. 26, 2006, which is hereby incorporated by reference herein in its entirety as if fully set forth herein.

### BACKGROUND OF THE INVENTION

The present invention relates generally to a storage and more particularly to a spacer that spaces two adjacent discs each serving as a recording medium at a predetermined interval in the disc drive. The present invention is suitable, for example, for a spacer that spaces plural discs in a hard disc drive (“HDD”).

Along with the recent spread of the Internet etc., a demand for fast and inexpensive recording of a large amount of information is growing. A magnetic disc drive, such as an HDD, is required to have a larger capacity, an improved response, and a lower price. For the larger capacity, the HDD increases a surface recording density on the disc and the number of installed discs. For the improved response, the rotation speed of a spindle motor is increased.

Plural discs are stacked around a hub fixed onto a rotating shaft of the spindle motor, and spaced at certain interval by one or more annular spacers. The spacer is fitted around a cylindrical-shaped hub, and both rotate together due to the fitting force. When the inner diameter of the spacer is too tight for the outer diameter of the hub, the spacer and/or the disc would deform, consequently lowering the head positing accuracy. On the other hand, when the inner diameter of the spacer is too loose for the outer diameter of the hub, the spacer vibrates or shifts the rotating disc as the hub rotates. In addition, the spacer would fluctuate the rotational center of the disc. Consequently, the head positioning accuracy lowers. The high recording density disc requires highly accurate head positioning. It is thus necessary to restrain vibrations applied to and deformations of the discs.

Accordingly, the spacer is required for a high dimensional precision in the micrometer level. Such a dimensional precision becomes increasingly severer together with the recently promoted large capacity and high response. In particular, the spacer is required for the high accurate shape on its inner surface facing the hub, and both contact surfaces that faces the medium disc.

The conventional spacer is made of metal or ceramic. A typical metallic spacer is manufactured through inner/outer diameters working with a rod or pipe material, cutting, and surface grinding of the medium contact surfaces. For reducing the cost, a reduction of the number of working steps is proposed through stamping method of a metallic plate member, and net shaping method, such as forging. On the other hand, a typical ceramic spacer is manufactured through ceramic powder preparations, molding, sintering, machining inner/outer diameters and grinding medium contact surfaces.

Prior art include, for example, Japanese Patent Applications, Publication Nos. 2002-334498 and 2005-196868.

However, the metallic spacer that undergoes the machining of metal rod or pipe takes much processing time. The metallic spacer that undergoes net shaping, such as forging, and stamping of a metallic plate member, essentially needs grinding medium contact surfaces, because the metallic plate member itself cannot avoid differences in thickness and warpage. On the other hand, the ceramic spacer needs machining the inner/outer surfaces and medium contact surfaces, because the dimensions changes significantly during sintering. In addition, the ceramic is a material hard to work, and is likely to generate micro-dust due to contacts and frictions with the spindle hub when the spacer is assembled into the disc drive.

For reducing the cost of the spacer, the improvement of the workability of the spacer is required. Accordingly, Japanese Patent Application No. 2004-254317 assigned to the same assignee proposes to manufacture a spacer through injection molding with resin. This application makes the uniform the resin flow and the uniform ejection force during mold releasing by adjusting a gate structure, a gate position, the number of gates, a releasing eject pin structure, an eject pin position, and the number of eject pins, etc. As a result, this application can mold a nearly net shaped disc spacer with an inner diameter circularity of 5 μm to 15 μm, an outer diameter circularity of 10 μm to 30 μm, and a flatness of each medium contact surface of 5 μm to 10 μm. These precisions are almost limits of the injection molding, and the outer diameter precision is sufficiently satisfactory.

On the other hand, the inner diameter tolerance needs the precision between 0 and 20 μm. For mass production purposes, the HDD is often required for a process capability index (“Cpk”) of 1.67 or greater. It is difficult even with the method of the above application to guarantee the inner diameter precision over the entire circumference. On the other hand, machining to satisfy the inner diameter tolerance would be contrary to a cost reduction purpose through the nearly net shape.

### BRIEF SUMMARY OF THE INVENTION

The present invention is directed to a spacer and its manufacturing method, and a disc drive having the spacer.

A spacer according to one aspect of the present invention is to be attached to a hub that rotates plural discs in a disc drive, configured to space two adjacent discs, and has an annular shape and an internal surface that opposes to the hub. The spacer includes three projections on the internal surface. It is enough for the spacer to control only the inner diameter precision of the projections, rather than controlling the inner diameter precision over the entire circumference of the inner surface of the spacer. Thus, the manufacturing yield improves. The spacer is preferably made of resin, and can be inexpensively manufactured through injection molding. The three projections are preferably arranged at intervals of 120°. A symmetrical arrangement of the projections can maintain the inner diameter precision of the spacer to be controlled.

A disc drive according to another aspect of the present invention includes plural discs each serving as a recording medium, a hub that rotates the plural discs, the plural discs being attached to the hub, and an annular spacer, which is attached to the hub, and configured to space two adjacent discs, the spacer including three projections on an internal surface of the spacer which opposes to the hub. This disc drive has a spacer that has a good workability and is less expensive.

A method according to another aspect of the present invention for manufacturing, using injection molding, an annular spacer to be attached to a hub that rotates plural discs in a disc drive, the spacer being configured to space two adjacent discs, the method comprising the steps of providing three projections on an internal surface of the spacer which opposes to the hub so that an inner diameter precision of the spacer can be controlled using a diameter of a virtual circle that passes vertexes of the three projections. According to this manufacturing method, it is enough to control the diameter precision of a virtual circle that passes projections, rather than controlling the inner diameter precision over the entire circumference of the inner surface of the spacer. The yield thus improves. The virtual circle is measured, for example, by a circularity measuring device. Control is made so that part of the inner circumference other than the projections does not enter the inside of the virtual circle determined by the projections.

Other objects and further features of the present invention will become readily apparent from the following description of the preferred embodiments with reference to accompanying drawings.

### BRIEF DESCRIPTION OF THE DRAWINGS

FIG. 1 is a perspective view showing an internal structure of a hard disc drive (“HDD”) according to one embodiment of the present invention.

FIG. 2 is a partially sectional and perspective view near the spindle motor shown in FIG. 1.

FIG. 3A is an enlarged plane view of a spacer shown in FIG. 2. FIG. 3B is a partially enlarged sectional view of FIG. 3A.

FIG. 4 is a flowchart for explaining a manufacturing method of the spacer.

FIG. 5 is a view for explaining a circularity tolerance zone.

### DETAILED DESCRIPTION OF THE PREFERRED EMBODIMENTS

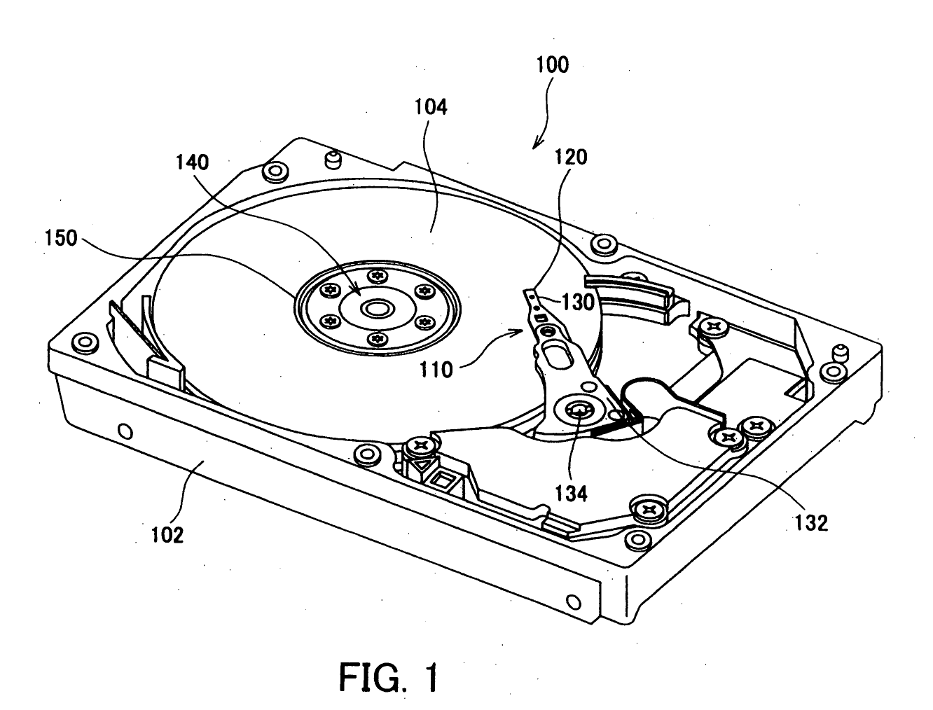

Referring now to the accompanying drawings, a description will be given of a HDD 100 according to one embodiment of the present invention. The HDD 100 includes, as shown in FIG. 1, plural magnetic discs 104 each serving as a recording medium, a head stack assembly (“HSA”) 110, a spindle motor 140, and clamp ring 150 in a housing 102. Here, FIG. 1 is a schematic perspective view of the internal structure of the HDD 100.

The housing 102 is made, for example, of aluminum die cast, and has a rectangular parallelepiped bathtub shape, to which a cover (not shown) that seals the internal space is jointed. The magnetic disc 104 of this embodiment has a high surface recording density, such as 200 Gb/in or greater. The magnetic disc 104 is mounted on a spindle hub of the spindle motor 140 through its center hole.

The HSA 110 includes a magnetic head part 120, a suspension 130, and a carriage 132.

The magnetic head part 120 includes a slider, and a thin-film read/write head device that is jointed with an air outflow end of the slider. The slider and head device define a medium opposing surface or floating surface. The floating surface receives the airflow generated as the magnetic disc 104 rotates.

The floating surface defines a so-called air-bearing surface (“ABS”). On the ABS, the floating force occurs according to the airflow. The head embedded in the head device exposes on the ABS. The floating method of the magnetic head part 120 is not limited to this embodiment, but may use the known dynamic pressure lubrication or another floating method.

The head is, for example, an MR inductive composite head that includes an inductive head device that writes binary information in the magnetic disc 104 utilizing a magnetic field generated by a conductive coil pattern (not shown), and a magneto resistive (“MR”) head that reads the binary information based on the resistance that varies in accordance with the magnetic field applied by the magnetic disc 104.

The suspension 130 serves to support the magnetic head part 120 and to apply an elastic force to the magnetic head part 120 against the magnetic disc 104. This type of suspension has a flexure (also referred to as a gimbal spring or another name) which cantilevers the magnetic head part 120, and a load beam (also referred to as a load arm or another name) which is connected to the base plate. The suspension 130 also supports a wiring part that is connected to the magnetic head part 120 via a lead etc. Via this lead, the sense current flows and read/write information is transmitted between the head and the wiring part.

The carriage 132 swings around a shaft 134 by a voice coil motor (not shown). A support portion of the carriage is referred to as an “arm,” which is an aluminum rigid body that can rotate or swing around the shaft 134. The carriage 132 is provided with a flexible printed circuit board (“FPC”). The FPC provides the wiring part with a control signal, a signal to be recorded in the disc 104, and the power, and receives a signal reproduced from the disc 104.

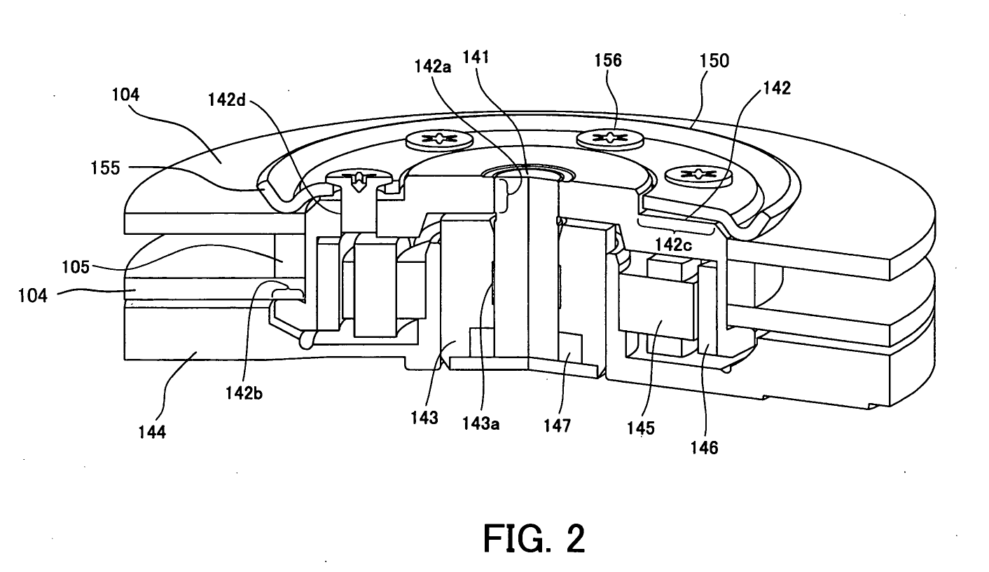

The spindle motor 140 rotates the magnetic disc 104 at such a high speed as 10,000 rpm, and has, as shown in FIG. 2, a shaft 141, a (spindle) hub 142, a sleeve 143, a bracket (base) 144, a core 145, and a magnet 146, an annular thrust plate 147, radial bearing (not shown). In this embodiment, the yoke serves as the hub 142. In addition, the hub 142 and the shaft 141 or the shaft 141 and the thrust plate 147 may be integrated. Here, FIG. 2 is a partially sectional and perspective view of the spindle motor 140.

The shaft 141 rotates with the discs 104 and the hub 142.

The hub 142 is fixed onto the shaft 141 at its top 142a, and supports the lower disc 104 on its flange 142b. The hub 142 has an annular attachment surface 142c to which a clamp ring 150 is attached. One or more (six in this embodiment) screw holes 142d are provided in the attachment surface 142c. Screws 256 are used to fix the clamp ring 150, and engaged with these screw holes 142d.

The sleeve 143 is a member that allows the shaft 141 to be mounted rotatably. The sleeve 143 is fixed in the housing 102. While the shaft 141 rotates, the sleeve 143 does not rotate and forms a fixture part with the bracket 144. The sleeve 143 has a groove or gap into which the lubricant oil is introduced. As the shaft 141 rotates, the lubricant oil generates the dynamic pressure (fluid pressure) along the groove.

The bracket (base) 144 is fixed onto the housing 102 around the sleeve 143, and supports the core (coil) 145, the magnet 146, and a yoke (not shown). The current flows through the core 145, the magnet 146, and the yoke that serves as the hub constitute a magnetic circuit. The thrust plate 147 is arranged at a bottom center of the sleeve 143, and forms the thrust bearing. The radial bearing (not shown) is a dynamic pressure bearing that supports the shaft 141 via the lubricant in a non-contact manner, and provided around the shaft 141 along the longitudinal direction of the shaft 141. The radial bearing supports the shaft 141 in the radial direction.

The clamp ring 150 serves to clamp the discs 104 and the spacer 105 onto the spindle motor 140. The clamp ring 150 is an annular disc member, and has plural screw holes 251b, into which the screws 156 are inserted, and a pressure portion 155. The pressure portion 155 fixes the discs 104 and the spacer 105 onto the spindle motor 140 with frictional force caused by thrust force.

The spacer 105 spaces plural discs 104 at a certain interval in the HDD 100. While this embodiment provides two discs, the number of discs is not limited. FIG. 2 shows that the lower disc 104 is supported on the flange 142b, the spacer 105 is arranged on its top, and the upper disc 104 is arranged on the spacer 105. Finally, the pressure portion 155 of the clamp ring 150 fixes two discs and the spacer at the center top of the upper disc 104. Thereby, two adjacent discs 104 are spaced at a predetermined interval by the spacer 105 around the hub 142 and between the flange 142b and the pressure portion 155.

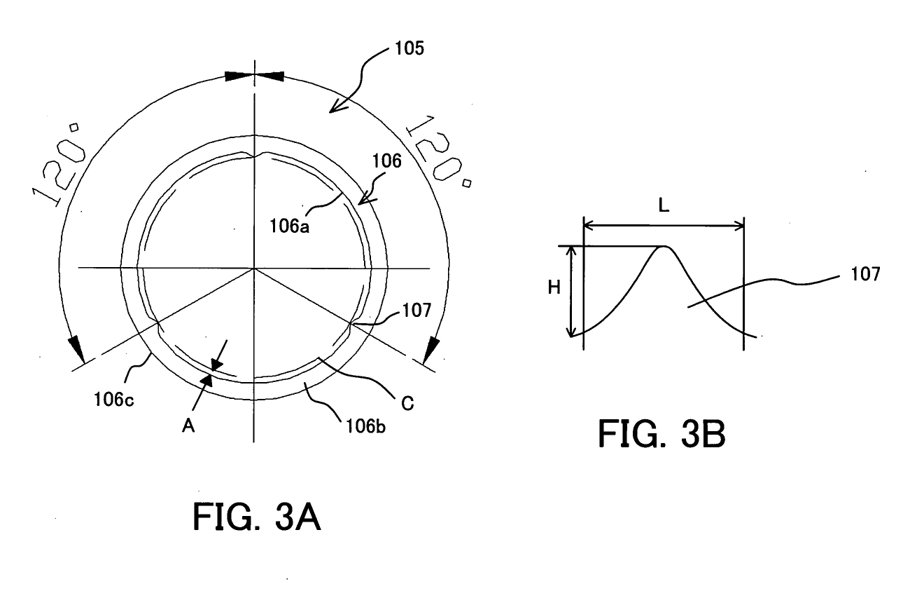

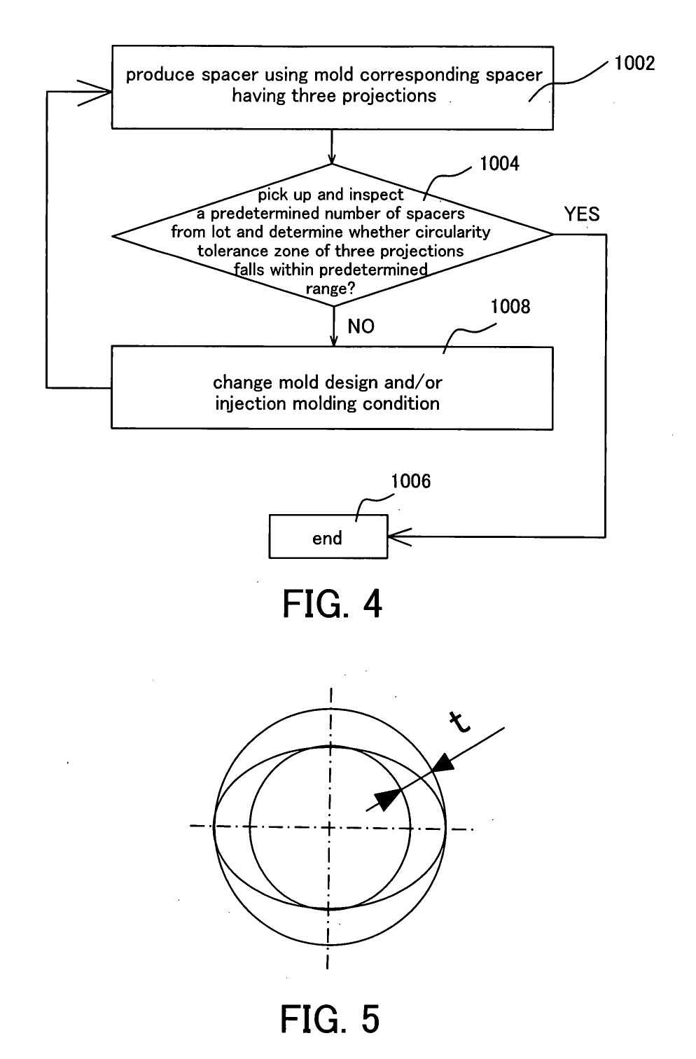

Referring now to FIGS. 3A and 3B, the spacer 105 will be described in detail. FIG. 3A is an enlarged plane view of the spacer 105.

The spacer 105 is attached around the hub 142, and serves to hold the two adjacent discs 104 at a predetermined interval corresponding to the thickness of the spacer 105. The spacer 105 has, as shown in FIG. 3A, a body 106, and three projections 107. The spacer 105 is preferably made of resin. When the spacer 105 is made of resin, it is manufactured by injection molding as disclosed in Japanese Patent Application No. 2004-254317. The method disclosed in this application can secure the high dimensional precision of the outer surface (outer diameter) and the medium contact surfaces of the spacer 105, which will be described later. This configuration can reduce or omit the machining step required for the metallic or ceramic spacer, improves the workability, and making the spacer 105 less expensive.

The body 106 has an annular or ring shape, and possesses an inner surface 106a, top and bottom medium contact surfaces 106b, and an outer surface 106c.

The inner surface 106a of the spacer 105 opposes to the hub 142, and has three projections 107. The inner surface 106a is positioned to the hub 142, and required for a high dimensional precision. When the inner diameter of the spacer 105 is too tight for the outer diameter of the hub 142, the spacer 105 and/or the disc 104 would deform. As a result, the head positioning accuracy lowers. On the other hand, when the inner diameter of the spacer 105 is too loose for the outer diameter of the hub 142, the spacer 105 vibrates or shifts the rotating disc 104 as the hub 142 rotates. As a consequence, the vibrations are applied to the hub 142, and the rotational center of the disc 104 fluctuates. The head positioning accuracy also lowers. The high recording density disc 104 needs a high head positioning accuracy. It is therefore necessary to restrain the vibrations applied to and the deformations of the disc. Accordingly, the spacer 105 is required for such a high dimensional precision of a micrometer level. This dimensional precision becomes increasingly severer as the recent promoted large capacity and the high response.

For example, the spacer 105 has an inner diameter of 20 mm, and its tolerance is required for 0 to 23 μm. However, the inner diameter is required for Cpk of about 1.67. Cpk of 1.67 means that a ratio of defective articles (fraction defective) is about 0.6 ppm, and the yield in process is very high. As a result, even if all spacers 105 in a lot are not inspected, if a necessary number of spacers 105 are picked up and inspected and the inner diameter precision is checked, the inner diameter precisions of all the spacers in the lot can be guaranteed. In order to satisfy Cpk of 1.67, the inner diameter tolerance of 3s (3' standard deviation) should be controlled within 6 μm.

The conventional inner surface is uniform and has no projection. Therefore, it is difficult to guarantee the tolerance over the entire circumference of the inner surface or 360°.

On the other hand, this embodiment forms three projections 107 on the inner surface so that the virtual circle diameter determined by the projections 107 can be guaranteed. Therefore, according to the spacer 105 of this embodiment, it is unnecessary to guarantee the tolerance over the entire circumference of the inner surface and it is enough to guarantee the tolerance only on the three projections 107. The guarantee of the inner diameter precision becomes easy, and the workability improves. In the net shape or nearly net shape method, the spacer 105 of this embodiment is particularly effective. The small number of contact points or the three contact points between the spacer 105 and the hub 142 can reduce micro-dust that would be generated due to the contact between the hub 142 and the spacer 105 in attaching the spacer 105 to the hub 142.

A fine gap A is formed between the internal surface 106a and a virtual circle C that passes tips of the three projections 107. The circle C shown in FIG. 3A corresponds to a virtual circle along which the motor hub contacts the spacer 105. The virtual circle C is measured by the circularity measuring device.

FIG. 3B is an enlarged plane view of the projection 107. The projections 107 have the same size and are arranged equiangularly at an angle of 120° around the center of the virtual circle. This symmetrical arrangement reduces the deformation of the spacer 105 and the stress applied to the hub 142, and maintains the inner diameter precision.

Each projection 107 has a height H and a width L. The average fluctuation of the circularity of the virtual circle C that inscribes the projections 107 is small among lots, and can be controlled within about 5 μm to 15 μm. Therefore, once the height H of the projection 107 is set to about 15 μm, part of the inner surface 106a other than the projections 107 can be set outside the virtual circle C determined by the projections 107. As a result, the inner surface 106a does not interfere with the hub 142. This embodiment sets the width L of the projection 107 between about 20 μm to about 40 μm, but the present invention does not limit the width L.

A tip of each projection 107 when viewed from the top of the spacer 105 as shown in FIG. 3B is preferably a point or a small region that can be regarded as a point. When the tip of the projection 107 has a width in the circumferential direction of the virtual circle C, a contact between the projection 107 and the hub 142 is an area contact rather than a point contact. Then, a circle that should be uniquely determined by three points is not determined. Since the hub 142 has a cylindrical shape, each projection 107 may extend in the thickness direction of the spacer 105 (or in a direction perpendicular to the paper plane of FIG. 3). When there is no width in the circumferential direction, a contact between the tip of the projection 107 and the hub 104 can be regarded as a point contact.

The top and bottom medium contact surfaces 106b of the spacer 105 contact and hold the central portions of the upper and lower discs 104. The outer surface 106c of the spacer 105 does not contact another member. The outer diameter of the spacer 105 is, for example, about 22 mm, and a tolerance is about 0.1 mm. This dimension can be sufficiently guaranteed by the injection molding.

A description will now be given of an embodiment of a manufacturing method of the spacer 105. Initially, the spacer 105 having the three projections 107 is manufactured with injection molding process by Japanese Patent Application No. 2004-254317 using a corresponding mold (step 1002). Next, a predetermined number of spacers 105 in a lot are picked up and inspected, and it is checked whether the circularity tolerance zone of the three projections 107 falls within a predetermined range (step 1004). The circularity tolerance zone is defined as a zone between two concentric circles that are apart from each other by “t” in FIG. 5. When the circularity tolerance zone falls within the predetermined range, the inner diameter precision of the spacer 105 falls within a given range and the procedure ends (step 1006). On the other hand, when the circularity tolerance zone is outside the predetermined range, the inner diameter precision of the spacer 105 is outside the given range and the procedure returns to the step 1002 by changing a mold design and/or an injection molding condition (step 1008). Thus, the manufacturing method of this embodiment uses a diameter of the virtual circle C that passes vertexes of the projections 107 to control the inner diameter precision of the spacer 105. Control over the inner diameter precision of only the three points is enough, and it is unnecessary to control the entire circumference of the inner surface of the spacer 105. This method can manufacture the spacer 105 with good workability.

In operation of the HDD 100, the spindle motor 140 is driven to rotate the discs 104. As discussed above, the spacer 105 has a predetermined fitting tolerance with the hub 142, the disc 104 have a high rotational precision, and a head positioning accuracy is high. A clash between the head and disc due to the micro-dust can be prevented.

The airflow generated with the rotation of the disc 104 is introduced between the disc 104 and slider, forming a thin air layer and thus generating the floating force that enables the slider to float over the disc plane. The suspension 130 applies an elastic force to the slider against the floating force of the slider. The balance between the floating force and the elastic force maintains the magnetic head part 120 from the disc 104 by a constant distance. Next, the carriage 132 is rotated around the shaft 134 for head seek for a target track on the disc 104. In writing, data is received from a host such as a PC, modulated and supplied to the inductive head. Thereby, the inductive head device writes down the data onto the target track. In reading, the MR head device is supplied with the predetermined sense current, and the MR head reads information from the predetermined track on the disc 104.

Further, the present invention is not limited to these preferred embodiments, and various modifications and variations may be made without departing from the spirit and scope of the present invention.

What is claimed is:

1. A spacer to be attached to a hub that rotates plural disc in a disc drive, said spacer being configured to space two adjacent discs, and having an annular shape and an internal surface that opposes to the hub, said spacer comprising three projections on the internal surface.

2. A spacer according to claim 1, wherein said spacer is made of resin.

3. A spacer according to claim 1, wherein the three projections are arranged at intervals of 120°.

4. A disc drive comprising:
plural discs each serving as a recording medium;
a hub that rotates the plural discs, the plural discs being attached to the hub; and
an annular spacer, which is attached to said hub, and configured to space two adjacent discs, the spacer including three projections on an internal surface of said spacer that opposes to the hub.

5. A method for manufacturing, using injection molding, an annular spacer to be attached to a hub that rotates plural disc in a disc drive, the spacer being configured to space two adjacent discs, said method comprising the step of providing three projections on an internal surface of said spacer which opposes to the hub so that an inner diameter precision of the spacer can be controlled using a diameter of a virtual circle that passes vertexes of the three projections.
